(19) United States
(12) Patent Application Publication
(10) Pub. No.: US 2022/0070234 A1
(43) Pub. Date: Mar. 3, 2022

(54) SYSTEMS AND METHODS FOR CONSOLIDATING CORRELATED MESSAGES IN GROUP CONVERSATIONS

(71) Applicant: Avaya Inc., Santa Clara, CA (US)

(72) Inventors: Pushkar Yashavant Deole, Pune (IN); Sandesh Chopdekar, Pune (IN); Navin Daga, Silapathar (IN)

(21) Appl. No.: 17/008,370

(22) Filed: Aug. 31, 2020

(51) Int. Cl. H04L 29/06; G06N 20/00; H04L 12/58

(52) U.S. Cl. CPC H04L 65/4023; G06N 20/00; H04L 51/16; H04L 51/046; H04L 51/22; H04L 65/4053

(57) ABSTRACT

Systems and methods of the present disclosure include receiving, at a user device associated with a first user of a plurality of users participating in a group chat conversation, electronic messages from one or more of the plurality of users, identifying data in a first message of the electronic messages associated with a topic, determining, based on the identified data, the first message is associated with the topic, receiving a request from the first user, and, in response to the request, rearranging the electronic messages in a user interface of the user device based on topic associations.

### FIELD

The disclosure relates generally to messaging applications and particularly to presenting group conversation data in a user-friendly manner.

### BACKGROUND

As electronic user devices such as smart phones, tablets, computers, etc., become more commonplace, more and more communication between people occurs via text communication applications such as WhatsApp, WeChat, Line, iMessage, etc. Apart from social networks, group conversations occur in enterprise communications using applications such as Slack. Besides simple one-to-one text communications, text communication often takes place between a large number of people. Social networking has become increasingly popular and is the preferred mode of communication by many users around the world. Social networking provides multiple ways to collaborate such as one-to-one chats, one-to-many chats, group chats, etc.

Text communication over the Internet has enabled real-time spread of information. A single text communication may comprise an endless number of text messages, audio recordings, images, and GIFs. With conventional communication applications, each message in a group communication is presented in a display of each user device for each user in the group communication in real-time after being sent by one of the users.

While the instantaneous delivery of messages enables real-time communication, the average human user cannot monitor real-time communications every moment. Also, group communication, or group chats, often result in a number of messages with little to no significance to some members of the group. Messages with particular significance to certain users may be buried between a large number of insignificant messages posted on the group. Often a single group communication may be hard to follow as messages belonging to different topics and/or threads of discussion may be scattered throughout the communication. Generally, users visit social networks at the end of a day or a few times in a day in order to view group messages as opposed to constantly viewing incoming messages in real-time.

In some scenarios a group may contain a large number of members and a great number of messages may be posted in a relatively short time span. For example, a single group communication on a social media site may include hundreds of participants. Each participant may be capable of posting new information at any time. The flow of conversation may constantly be changing as different participants post different posts. A first participant may respond to an earlier post while a second participants may change the subject. A third participant may ignore the changed subject and add a new post in reply to the first participant's response. The resulting text document may consist of hundreds of different topics. When a fourth participant, such as a user of a client device, first sees the group communication, the feeling may be overwhelming and may be faced with an extremely difficult and/or time consuming task of deciphering the hundreds or thousands of different posts relating to hundreds of different topics. Such an issue may arise in social media, text message groups, iMessage groups, private Internet forums, public Internet forums, closed communication systems managed by business entities, etc.

What is needed is a communication system capable of resolving the above described issues with conventional communication systems.

### BRIEF DESCRIPTION OF THE DRAWINGS

FIG. 1 is a block diagram of a first illustrative system for implementing a group communication in accordance with one or more embodiments of the present disclosure;

FIG. 2A is a block diagram of a user device system for executing a group communication in accordance with one or more embodiments of the present disclosure;

FIG. 2B is a block diagram of a server for executing a group communication in accordance with one or more embodiments of the present disclosure;

FIG. 3A is an illustration of a table or database in accordance with one or more embodiments of the present disclosure;

FIG. 3B is a block diagram of a machine learning system in accordance with one or more embodiments of the present disclosure;

FIG. 4A is a block diagram of a data packet in accordance with one or more embodiments of the present disclosure;

FIG. 4B is a block diagram of a data packet in accordance with one or more embodiments of the present disclosure;

FIG. 5A is a flow diagram of an interchange of data in accordance with one or more embodiments of the present disclosure;

FIG. 5B is a flow diagram of an interchange of data in accordance with one or more embodiments of the present disclosure;

FIG. 6A is an illustration of a user interface in accordance with one or more embodiments of the present disclosure;

FIG. 6B is an illustration of a user interface in accordance with one or more embodiments of the present disclosure;

FIG. 6C is an illustration of a user interface in accordance with one or more embodiments of the present disclosure;

FIG. 7A is a flow diagram of a process in accordance with one or more embodiments of the present disclosure;

FIG. 7B is a flow diagram of a process in accordance with one or more embodiments of the present disclosure; and

FIG. 7C is a flow diagram of a process in accordance with one or more embodiments of the present disclosure.

### DETAILED DESCRIPTION

The above discussed issues with contemporary communication applications and other needs are addressed by the various embodiments and configurations of the present disclosure. As described herein, messages in a group chat or other form of group communication may be mined so as to consolidate related messages together to provide users with a user interface showing a parent topic with key points discussed in the topic and group of messages belonging to that topic up front. Such a system as described herein provides a rich experience to the user.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

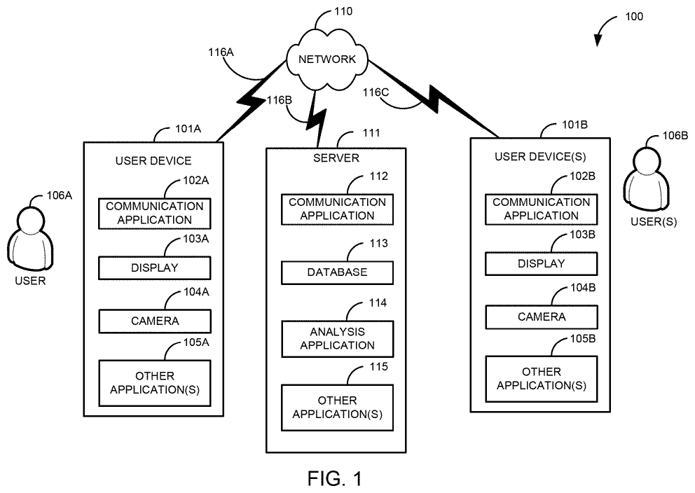

FIG. 1 is a block diagram of a first illustrative system 100 for a group communication between one or more users in accordance with one or more of the embodiments described herein. The first illustrative system 100 comprises user communication devices 101A, 101B and a network 110. In addition, users 106A-106B are also shown.

The user communication devices 101A, 101B can be or may include any user device that can communicate on the network 110, such as a Personal Computer (“PC”), a video phone, a video conferencing system, a cellular telephone, a Personal Digital Assistant (“PDA”), a tablet device, a notebook device, a smartphone, and/or the like. The user communication devices 101A, 101B are devices used as endpoints for a group communication. Although only two user communication devices 101A, 101B are shown for convenience in FIG. 1, any number of user communication devices 101 may be connected to the network 110 for establishing a group communication.

The user communication devices 101A, 101B further comprise communication applications 102A, 102B, displays 103A, 103B, and cameras 104A, 104B. It should be appreciated that, in some embodiments, user devices may lack cameras 104A, 104B. Also, while not shown for convenience, the user communication devices 101A, 101B typically comprise other elements, such as a microprocessor, a microphone, a browser, other applications, and/or the like.

In addition, the user communication devices 101A, 101B may also comprise other application(s) 105A, 105B. The other application(s) 105A can be any application, such as, a slide presentation application, a document editor application, a document display application, a graphical editing application, a calculator, an email application, a spreadsheet, a multimedia application, a gaming application, and/or the like. The communication applications 102A, 102B can be or may include any hardware/software that can manage a group communication that is displayed to the users 106A, 106B. For example, the communication applications 102A, 102B can be used to establish and display a group communication.

The displays 103A, 103B can be or may include any hardware display/projection system that can display an image of a video conference, such as a LED display, a plasma display, a projector, a liquid crystal display, a cathode ray tube, and/or the like. The displays 103A-103B can be used to display user interfaces as part of communication applications 102A-102B.

The user communication devices 101A, 101B may also comprise one or more other application(s) 105A, 105B. The other application(s) 105A, 105B may work with the communication applications 102A, 102B.

The network 110 can be or may include any collection of communication equipment that can send and receive electronic communications, such as the Internet, a Wide Area Network (WAN), a Local Area Network (LAN), a Voice over IP Network (VoIP), the Public Switched Telephone Network (PSTN), a packet switched network, a circuit switched network, a cellular network, a combination of these, and the like. The network 110 can use a variety of electronic protocols, such as Ethernet, Internet Protocol (IP), Session Initiation Protocol (SIP), H.323, video protocol, video protocols, Integrated Services Digital Network (ISDN), and the like. Thus, the network 110 is an electronic communication network configured to carry messages via packets and/or circuit switched communications.

The network may be used by the user devices 101A, 101B, and a server 111 to carry out communication. During a group communication, data 116A may be sent and/or received via user device 101A, data 116B may be sent and/or received via server 111, and data 116C may be sent and/or received via user device 101B.

The server 111 may comprise any type of computer device that can communicate on the network 110, such as a server, a Personal Computer (“PC”), a video phone, a video conferencing system, a cellular telephone, a Personal Digital Assistant (“PDA”), a tablet device, a notebook device, a smartphone, and/or the like. Although only one server 111 is shown for convenience in FIG. 1, any number of servers 111 may be connected to the network 110 for establishing a group communication.

The server 111 may further comprise a communication application 112, database(s) 113, analysis applications 114, other application(s) 115, and, while not shown for convenience, other elements such as a microprocessor, a microphone, a browser application, and/or the like. In some embodiments, analysis applications 114 may comprise a text analysis engine and a topic analysis engine. The text and topic analysis engines may be configured to execute one or more components based on machine learning and/or natural language processing. In some embodiments, machine learning and/or natural language processing algorithms may be executed by the server itself to carry out the work of topic identification and consolidation, while in other embodiments, the server may access one or more third party services provided by cloud service providers for machine learning and/or natural language processing for topic identification from text messages. In some embodiments, a combination of server-executed artificial intelligence systems and third part based systems may be used.

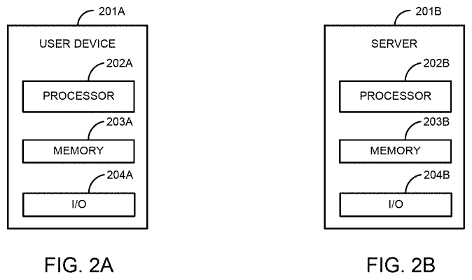

FIGS. 2A and 2B illustrate components of an exemplary user device 201A and server 201B for use in certain embodiments as described herein.

In some embodiments, a user device 201A may comprise a processor 202A, memory 203A, and input/output devices 204A. Similarly, a server 201B may comprise a processor 202B, memory 203B, and input/output devices 204B.

A processor 202A, 202B may comprise a processor or microprocessor. As used herein, the word processor may refer to a plurality of processors and/or microprocessors operating together. Processors 202A, 202B may be capable of executing software and performing steps of methods as described herein. For example, a processor 202A, 202B may be configured to display user interfaces on a display of a computer device. Memory 203A, 203B of a user device 201A, 201B may comprise memory, data storage, or other non-transitory storage device configured with instructions for the operation of the processor 202A, 202B to perform steps described herein. Accordingly, processes may be embodied as machine-readable and machine-executable code for execution by a processor to perform the steps herein and, optionally, other processing tasks. Input/output devices 204A, 204B may comprise, but should not be considered as limited to, keyboards, mice, microphones, cameras, display devices, network cards, etc.

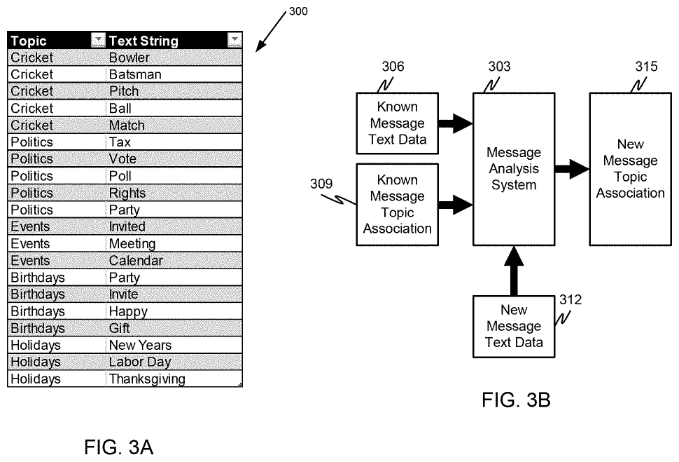

FIG. 3A is an illustration of contents of a database 300 which may be stored in memory of a user device 201A and/or server 201B. In some embodiments, a database 300 may be primarily stored on a server 201B and may be shared with one or more user devices 201A as needed. In some embodiments, database 300 may be unique for a particular user, for a particular group of users, for a particular group communication, etc. For example, a database 300 as illustrated in FIG. 3A may comprise a list of text strings associated with certain topics. Each text string may be one or more words which may be used to identify whether a message is associated with a particular topic. For example, the word “batsman” may be associated with the topic “cricket” while the word “party” may be associated with one or both of topics “politics” and “birthdays.”

In some embodiments, a database may be created for a particular type of business or other entity. For example, a database may comprise topics relating to a bank. Such a database may be used for users working for a bank or working with a bank, for example customers or clients of a bank. In this way, databases maybe particularly relevant to an entity by comprising the types of words and phrases used within a particular industry or company.

In some embodiments, databases may be continuously edited with additions and/or subtractions as more topics are identified and refined.

While the illustrative example of FIG. 3A describes a rule based system in which a system compares text strings and makes determinations relating to topic, it should be appreciated this description is for illustrative purpose only and should not be considered as limiting the scope of disclosure in any way. For example, a more complex training database may be used leveraging the use of several input parameters to be used by machine learning and/or natural language processing systems which may be configured to learn from training data, to extract and analyze portions of text, and to make a determination about a topic or topics of a message.

Furthermore, depending on algorithms or models employed by the machine learning and/or natural language systems, the structure of the training database may vary significantly. For example, a training database may be a non-structured or non-relational object database and may differ significantly than what is illustrated in FIG. 3A.

As illustrated in FIG. 3B, a server or user device may execute a message analysis system 303. A message analysis system 303 may execute one or more machine learning or deep learning algorithms. The message analysis system 303 may be trained using known message text data 306 and known message topic association data 309. The known message text data 306 and topic association data 309 may comprise data used to train the message analysis system 303, which may be referred to in some embodiments as a deep learning/machine learning model. As new messages are received as part of a group communication, text data from the new messages 312 may be fed into the trained message analysis system 303. The message analysis systems 303 may be configured to output a topic association 315 for each new message text data 312. New message text data may comprise one or more text keywords extracted from a new message.

Training of a message analysis system 303 may comprise providing data in the form of examples with labels to the message analysis system 303. Such example-label pairs may be fed to a learning algorithm one by one, allowing the algorithm to predict a label, such as a topic title, for each example. Feedback may be provided to the message analysis system 303 as to whether or not the message analysis system 303 predicted the proper topic of the training message text data. Over time, the message analysis system 303 may be trained to approximate the exact nature of the relationship between examples (e.g., known message text data 306) and their labels (e.g., known message topic associations 309). When fully-trained, the message analysis system 303 may be capable of observing a new, never-before-seen example text message and predicting a proper topic or topics for the message.

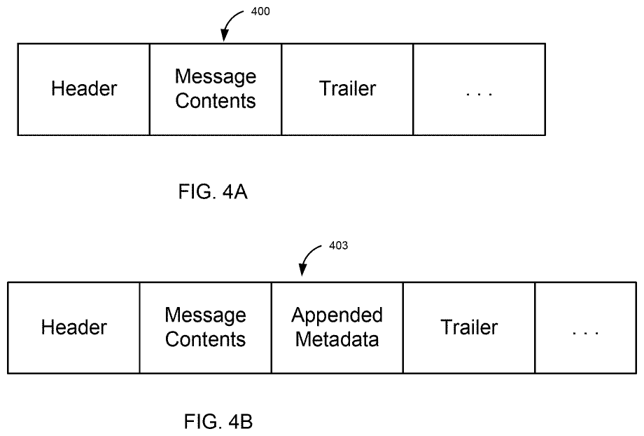

As illustrated in FIG. 4A, a message may be sent between devices in the form of a data packet 400. A data packet 400 may comprise one or more data blocks such as a header, message contents, a trailer, or other type of information. A header of a data packet 400 for a message may comprise information such as an identity of a sender of the message, an identity of a recipient or recipients of the message, a timestamp indicating a date and/or time the message was sent, or other types of information. Message contents of a data packet 400 may comprise text or image data which is to be sent in the form of message to one or more other units or devices. A trailer of a data packet 400 may comprise information similar to the header of the data packet 400 or other type types of data and or metadata for the message which must be included in the data packet 400.

As illustrated in FIG. 4B, a data packet 403 may be appended with metadata or other types of data in addition to the basic contents of a message data packet 400 as illustrated in FIG. 4A. For example, when a user of a user device sends a message as part of a group communication, the message may be sent in the form of a data packet 400 to a server via a network connection. The server may receive the data packet 400 and transmit the message to one or more other user devices. In some embodiments, the server may be configured to analyze the message. Analyzing the message may comprise the text of the message being analyzed to determine whether the message contents relate to any one or more of a number of topics. The server may be configured to, after determining the message contents are related to a topic, append the data packet 400 with additional metadata to create an appended message data packet 403. Such appended metadata may comprise, for example, a list of topics to which the message relates, an indication as to which portions of the message relates to which topic, or other information.

In some embodiments, users may be capable of using a user device to manually select a topic for a particular message. In such embodiments, a message data packet may be appended prior to being transmitted from the user device via the network. The message data packet may be appended to include metadata such as a name of the topic or topics to which the message relates, an indication as to what portions of the message relate to the topic or topics, an identity of the user selecting the topic or topics to which the message relates, etc.

Illustratively, the user communication devices 101A, 101B, the communication applications, the displays, the application(s), are stored-program-controlled entities, such as a computer or microprocessor, which performs the methods and the processes described herein by executing program instructions stored in a computer readable storage medium, such as a memory (i.e., a computer memory, a hard disk, and/or the like). Although the methods described herein may be shown in a specific order, one of skill in the art would recognize that the steps of systems and methods described herein may be implemented in different orders and/or be implemented in a multi-threaded environment. Moreover, various steps may be omitted or added based on implementation.

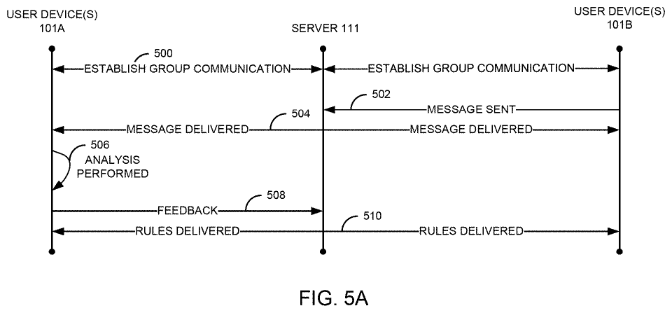

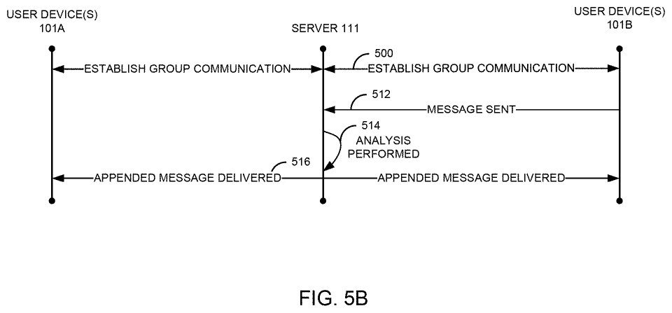

FIG. 5A is a flow diagram of a process using a communication application to exchange messages between two or more user devices 101A, 101B of users participating in a group communication. The process starts when a group communication is established at 500. A group communication may be established for example when one user of a user device uses a messaging app or other type of communication application to send a message, such as the text message, to one or more other users of user devices. The users being sent the message may be considered as being within a same group as the sender of the message. When the group communication is established, messages may be sent between user devices 101A, 101B participating in the group communication and/or a server 111.

Once a group communication is established, user devices may be free to send messages to other user devices participating in the group communication. For example, user device 101B may send a message via the communication application at 502. Messages sent from user device 101B may be sent to the server 111 prior to being distributed to other user devices. In some embodiments, messages may be delivered without further analysis by the server 111 at 504. In such embodiments, analysis of topic content to which messages may be associated may be performed by receiving user device 101A, or other user devices, at 506. Performing analysis may comprise the user device 101A analyzing a text string and a certain message and comparing the text string to one or more databases. Databases, as illustrated in FIGS. 3A and 3B, may comprise a list of topics and a list of one or more text strings for each topic. The existence of a text string of a database matching a text string in the message may be enough evidence to designate the message as being associated with a given topic. For example, a message containing the word “meeting” may be associated with a topic “events” whereas a message with the word “gift” maybe associated with a topic “birthdays.” In some embodiments, one message may be associated with multiple topics if the message contains multiple text strings identified as being associated with multiple topics in a database or databases. The analysis performed by user device 101A may be performed automatically. For example, a neural networks such as a convolutional neural network or other type of artificial intelligence system may be used. In some embodiments, analysis performed by a user device may comprise utilizing a communication application on on the user device to leverage third party artificial intelligence service providers hosted in a public cloud such as Google AI or a similar provider.

In such embodiments, feedback may be sent from the user device 101A performing the analysis back to the server 111 at 508. The server 111 may receive the feedback and may use the feedback to generate one or more rules and deliver the rules to each user device 101A, 101B participating in the group communication at 510. In some embodiments, feedback may consist of a text string identified within a message and the text of the message along with the topic with which the text string is associated.

The server 111 may create rules based on received feedback. For example, when a user of a user device receives a message, the user or the user device may analyze the message to determine whether the message is associated with one or more topics. The analysis of the message may be done automatically by the user device or manually by the user of the user device. Feedback may consist of an indication as to which portion of the message applies or is associated to each topic or may simply be in the form of the message contents with the identity of the one or more topics to which the messages associated. By sharing the feedback from the user device to the server and or other user devices, this server and or other user devices may be capable of identifying future messages associated with the same topic. In this way, the server may update a database of topics and keywords or may train an artificial intelligence system capable of automatically analyzing future messages.

As illustrated in FIG. 5B, the analysis of messages may be performed by a server 111. As discussed above, a group communication may be established at 500. A message may be sent from a user device 101B at 512 and may be received by the server 111. When the server 111 receives a new message at 512, the server 111 may perform analysis at 514 prior to delivering the message to other user devices 101A participating in the group communication. As described herein, analysis performed by the server 111 or other user devices 101A, 101B, may comprise a simple text look up comparing the message contents to one or more databases containing keywords associated with topics or may comprise feeding the message contents into a neural network which may be configured to accept text input and to output a list of one or more topics with which the message contents may be associated. When the server 111 performs the analysis and determines one or more topics with which the message sent from the user device 101B is associated, the server 111 may append the message with metadata identifying the one or more topics with which the message is associated. The appended message may be delivered to each user device 101A, 101B participating in the group communication. In this way, each user device 101A, 101B, including the user device having sent the message at 512, may be notified as to with which one or more topics the message is associated.

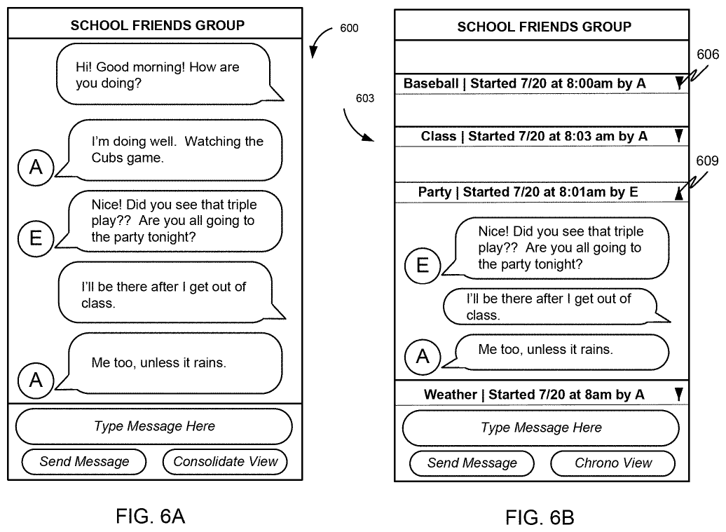

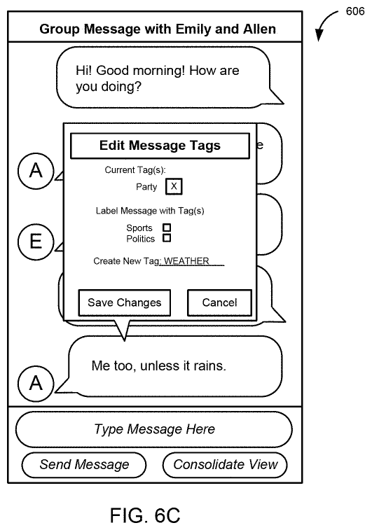

As messages are received by a user device participating in a group communication, the messages may be displayed in the order received in the user interface 600 as illustrated in FIG. 6A. In the example illustrated in FIG. 6A, a first user of a first user device is communicating with users Emily and Allen. As should be appreciated, the group conversation including the user of the user device displaying the user interface 600 along with Emily and Allen may be just one of many group conversations involving one or more of the user, Emily, and Allen. For example, the user of the user device may simultaneously be receiving messages from any number of users in any number of group and/or one-on-one communications.

Messages sent from the first user of the first user device may be displayed in line with messages received from the users Emily and Allen. Messages from the users Emily and Allen may be displayed along with the indication of which user sent the message. The user interface 600 may include an identification of the group message for example a title of the group message displayed at the top of the user interface 600. For example, a title such as “School Friends Group” may be displayed. The user interface 600 may also include a text box enabling the first user of the first user device to input a message to be sent to the group. The user interface 600 may also include a graphical user interface button configured to enable the first user to switch a view type for the user interface 600. For example, a “show consolidated view” graphical user interface button may enable the user to switch from a chronological view user interface 600 to a consolidated view user interface 603 as illustrated in FIG. 6B.

As illustrated in FIG. 6B, a consolidated view user interface 603 may display messages of the group communication organized based on identified topics. In some embodiments, one message associated with multiple topics may be displayed multiple times. In the exemplary embodiment displayed in FIGS. 6A and 6B, messages have been identified as relating to a baseball topic and a party topic. For example, the words “Cubs game” may be used to automatically identify that the first message from user Allen Is related to the topic baseball. Similarly, the message from the user Emily with the words “triple play” may also be used to identify that the first message from the user Emily relates to the topic baseball. The words “party” may be used to identify the same message from the user Emily also relates to the topic “party.”

As can be appreciated from FIG. 6B, topics may be collapsible such that one or more topics may be collapsed while one or more other topics may be expanded. In the example illustrated in FIG. 6B, a “party” topic 609 is expanded to show the messages associated with “party,” while a “baseball” topic 606 is collapsed to hide messages associated with “baseball.” In some embodiments, regardless of whether a topic is collapsed or expanded, the topic title may be shown along with information such as which user started the topic (e.g., by sending a first message associated with the topic), a date and/or time the topic was started (e.g., a timestamp indicating when the first message associated with the topic was sent, or other information. In some embodiments, such information may be shown only when the topic is expanded and not shown when the topic is collapsed, or vice versa.

In some embodiments, the user device or server used to analyze the messages may be enabled to analyze messages based in part on context. For example, the message sent from the first user of the user device including the words “I'll be there after I get out of class” may be identified as being associated with the topic party due in part to its proximity and time to the message from Emily including the word party. In the same way, the message from Allen including the words “me too” may also be identified as being associated with the topic party.

In some embodiments, a consolidated view may comprise a display of a parent topic with key points discussed in the topic being highlighted or listed near the messages in the topic. For example, key points discussed in a topic may be identified automatically by a processor similar to the process of identifying a topic. In some embodiments, within a topic there may be a number of subtopics or important points made. For example, if a topic is relating to a party, a time and location of the party may be identified as being important key points. Such key points may be displayed in a user interface in the form of a list or may be highlighted within messages.

A processor may be configured to execute an intelligent classification system capable of identifying topics and/or threads of discussion within a group, classifying messages as being associated with the identified topics and/or threads of discussion within the group, and consolidating the messages under the parent topic and present the user or users with a ordered view of related messages consolidated together along with the key points discussed in the topic.

Each topic may be displayed with a topic title, an indication as to the user of the group communication who started the topic discussion and a timestamp indicating the time when the topic was started.

Users may be enabled to select a time range, e.g., last 1 hour, last 3 hours, last 5 hours, last 12 hours. After a user selects a time range, the messages received in that timeframe may be displayed to the user. Also, activity, such as topics started, messages posted under those topics, etc., may be displayed in a user-friendly format.

In some embodiments, a user interface may be configured to enable users to view only messages posted by a particular user relating to a particular topic. For example, if a user selects a particular message within a topic and keeps the poster of the message selected for few seconds, then messages posted by that member within that group may be consolidated and displayed to the user. In some embodiment, messages posted by the selected user relating to multiple topics may also be displayed.

The user interface 603 may include a graphical user interface button enabling the user of the user device to switch back from the consolidated view user interface 603 to the chronological view user interface 600.

As illustrated by the user interface 606 of FIG. 6C, a user of the user device may be capable of interacting with the user interface 606 to add or edit tags of a particular message sent from any of the users participating in the group communication. To activate the add or edit tags screen, a graphical user interface button may be used, or in some embodiments the user may interact with the touch screen. For example, a long press or a hard press on a certain message may display the edit message tags user interface screen. An edit message tags user interface screen may comprise a listing of current tags currently associated with the selected message.

The edit message tags user interface screen may also include a list of potential topics which the message maybe associated with. Such potential topics with which the message may be associated may be a list including topics associated with other messages in the group communication. The edit message tags user interface screen may further comprise a text field enabling the user to create a new tag by typing in a word such as “weather.” The user of the user device may be capable of hitting a save changes graphical user interface button to save the changes to the tags of the message or to hit a cancel button to close the edit message tags user interface screen without making any changes.

When a user of a user device edits tags of a particular message, the edits may be shared with the other user devices participating in the group communication and/or one or more servers. The sharing of manually edited tags may be used to train a neural network or other type of artificial intelligence system designed to analyze messages or to update a database of keywords and topics.

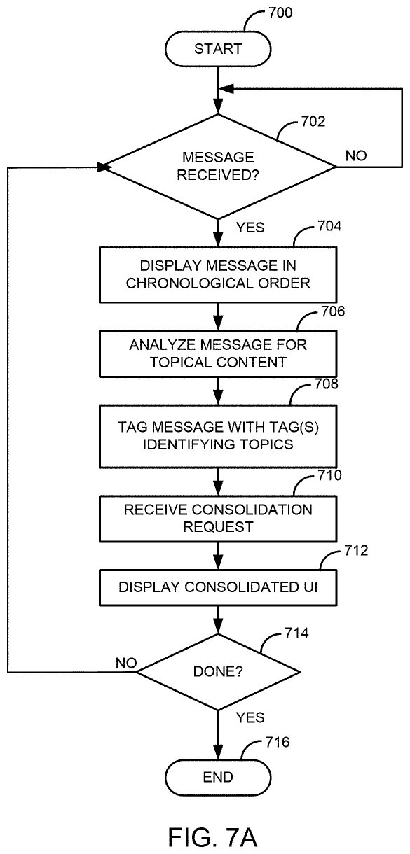

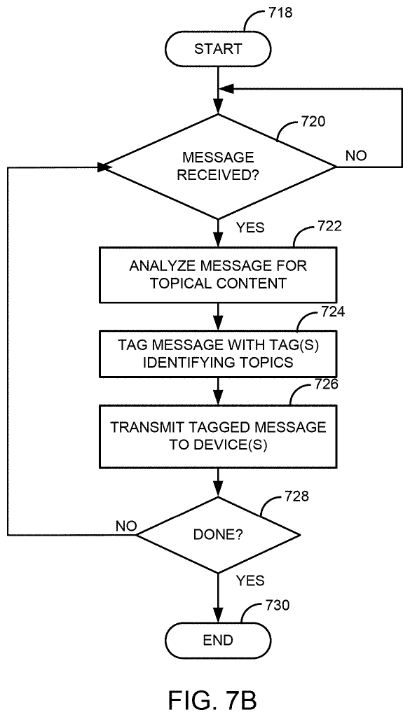

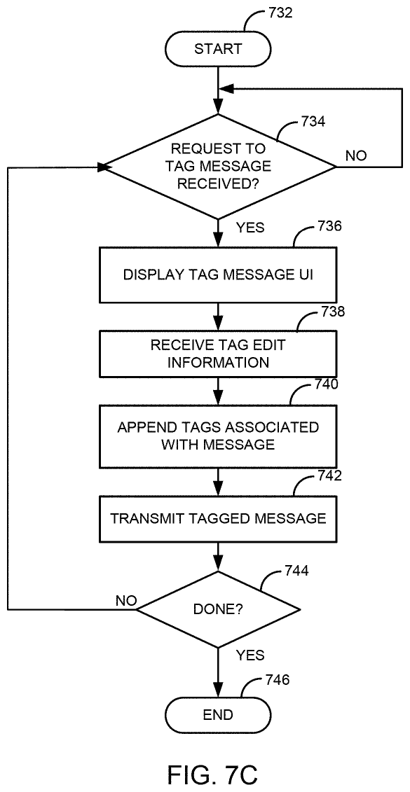

As illustrated in FIG. 7A, a process of executing a group communication may be performed by a processor of a user device. The process of FIG. 7A may begin at step 700 in which a group communication between two or more user devices has been established. The group communication may be, for example, a group message using a text communication application such as iMessage, WhatsApp, etc., or an online discussion such as an Internet forum or a text instant messaging application. At step 702, a processor of a user device may wait for a message to be received. The message may be received from another user device or from the instant user device, for example by the user of the user device typing in a message and clicking send. Once a message has been received at step 702, the message may be displayed in chronological order in the messaging application on the user device at 704. At 706, the message may be analyzed to determine whether any of the content in the message is associated with one or more topics.

As described herein, messages may be analyzed automatically by a user device or a server or manually by user of the user device. One or more databases or artificial intelligence systems may be used to analyze a message for topical content. If topical content is found in a message the message may be tagged with one or more tags identifying the one or more topics contained within the message at 708. At 710, a user of the user device may request a consolidated view user interface, for example by clicking a graphical user interface button. At 712, when the processor receives the consolidation request, the user interface may be changed from a chronological view user interface to a consolidated view user interface for example as illustrated in FIG. 6B. At step 714, the processor may determine whether the process has been completed. For example, if the user of the user device closes the group communication the process may end at step 716. If, on the other hand, the process is not completed the processor may continue to wait for additional messages to be received at step 702. It should be appreciated that messages may be received regardless of whether the user interface is in the chronological view user interface or the consolidated view user interface. In some embodiments, newly arrived messages may be arranged and displayed accordingly with respect to a selected user interface view. For example, if the consolidated view is selected then new incoming message arriving after the selection of the consolidated view would automatically be rolled up under the appropriate topic. Moreover, neither user interface may be required to be displayed for a message to be received as should be appreciated.

In some embodiments, an artificial-intelligence-based message analyzer may be capable of making use of one or more machine learning libraries or databases. Such an artificial-intelligence-based message analyzer may be capable of identifying messages that are generic, e.g., “good morning,” “have a good day,” “good night,” etc. Such generic messages may be consolidated under a general greetings topic.

An artificial-intelligence-based message analyzer may be capable of identifying messages that are occasional and generally of importance to any user. For example, messages such as someone is ill/sick, or someone needs some emergency help, someone met with accident or hospitalized or messages related to demise etc., may be identified and displayed under an appropriate topic label.

Similarly, an artificial-intelligence-based message analyzer may be capable of identifying a topic of discussion from a first message posted on that topic, e.g. a topic identified may be for example, birthday wishes (including a name of the person having the birthday, politics (including a name of a political person or party), sports (including a name of a sport and/or a team or league), event planning (including an identification of the event), etc.

An artificial-intelligence-based message analyzer may be capable of identifying several messages scattered throughout a group communication belonging to a same topic and consolidating the identified messages under the same topic by attaching an appropriate tag to each message along with an identification of which user posted the message and the time at which the message was posted or sent.

Also, key points discussed in a topic may be identified. In some embodiments, within a topic there may be a number of subtopics or important points made. For example, if a topic is relating to a party, a time and location of the party may be identified as being important key points. Such key points may be displayed in a user interface in the form of a list or may be highlighted within messages.

As illustrated in FIG. 7B, in some embodiments, messages may be analyzed prior to being displayed on a user device. For example, the messages may be analyzed by a server prior to distributing the messages to the user devices participating in the group communication. The process of FIG. 7B may begin at step 718 in which a group communication between two or more user devices has been established. The group communication may be, for example, a group message using a text communication application such as iMessage, WhatsApp, WeChat, etc., or an online discussion such as an Internet forum or a text instant messaging application. At step 720, a processor of a server or a user device may wait for a message to be received. The message may be received from a user device participating in the group communication. Once a message has been received at step 720, the message may be analyzed to determine whether any of the content in the message is associated with one or more topics at step 722. As described herein, messages may be analyzed automatically by a user device or a server or manually by user of the user device. One or more databases or artificial intelligence systems may be used to analyze a message for topical content. If topical content is found in a message, the message may be tagged with one or more tags identifying the one or more topics contained within the message at 724. At 726, the tagged message may be sent to the user devices participating in the group communication in the form of an appended message data packet. At step 728, the processor may determine whether the process has been completed. For example, if the user of the user device closes the group communication or otherwise ends the group communication the process may end at step 730. If, on the other hand, the process is not completed the processor may continue to wait for additional messages to be received at step 720.

As illustrated in FIG. 7C, a process for enabling users to manually tag one or more messages with one or more tags identifying that the message or messages are associated with one or more topics may be performed by processor of a user device participating in a group communication. Such a process may begin at step 732 in which the user device is participating in a group communication. The user device may be displaying messages of the group communication and the user interface such as illustrated in FIGS. 6A and 6B. At step 734, the user device may receive a request to tag a message from the user of the user device. For example, the user of the user device may select a graphical user interface button or may otherwise initiate a process of tagging messages. If no request to tag a message is received at step 734 the process may continue by waiting for the request to be received. Once a request to tag a message is received at step 734, the processor of the user device may cause to be displayed a tag message user interface such as that illustrated in FIG. 6C in step 736. At step 738, the processor of the user device may receive tag edit information via a user's input in the tag message user interface. For example, the user may click checkboxes next to existing topics or may type in the name of a new topic for the message. Based on the received tag edit information, the processor of the user device may append one or more tags associated with the message to the message. In some embodiments, the tagged message may simply be stored within the user device memory or, as illustrated in FIG. 7C at step 742, the tagged message may be sent in the form of an appended message data packet to a server and or one or more other user devices participating in the group communication. In this way, information relating to topics of messages may be shared between devices participated in the group communication and may be used to train a neural network for use in analyzing future communications. At step 744, the processor may determine whether the process is complete. For example, if the group communication has ended the process may be determined to have been completed and the process may end at step 746. If the process has not been completed, the processor may continue to wait for a request to tag message to be received at step 734.

Embodiments of the present disclosure include a method comprising: receiving electronic messages from one or more user devices associated with a plurality of users participating in a group communication; identifying data in a first message of the electronic messages associated with a topic; determining, based on the identified data, the first message is associated with the topic; receiving a request from a first user; and in response to the request, rearranging the electronic messages in a user interface of the user device based on topic associations.

Aspects of the above method include the method further comprising receiving a second request from the first user; and in response to the second request, rearranging the electronic messages in the user interface based on the chronological order.

Aspects of the above method include wherein identifying data in the first message of the electronic messages associated with the topic comprises comparing one or more text strings contained within the first message to text strings in a learning database comprising training data, wherein the training data is used for machine learning.

Aspects of the above method include wherein each text string in the training data comprised by the learning database is associated with a particular topic.

Aspects of the above method include the method further comprising: after rearranging the electronic messages in the user interface based on topic associations, receiving a new message from one of the plurality of users; identifying data in the new message associated with the topic; determining, based on the data associated with the topic, the new message is associated with the topic; and after determining the new message is associated with the topic, displaying the new message in the user interface within a group containing the first message.

Aspects of the above method include the method further comprising displaying the first message in the user interface and displaying one or more of a title of the topic, an identification of a user participating in the communication group having started the topic, a timestamp indicating a date and/or time the topic was started, a graphical user interface button enabling a collapsible view, a graphical user interface button enabling filtering based on time, a graphical user interface button enabling a user to view all of messages posted by a particular user of the plurality of users participating in the group communication within the topic and/or across topics.

Aspects of the above method include wherein determining the first message is associated with the topic is performed by a processor of one of a server and one of the user devices.

Aspects of the above method include wherein the new topic and text of the second message are stored in a learning database.

Aspects of the above method include wherein a third message is automatically identified as being associated with the new topic based on the text of the second message.

Aspects of the above method include the method further comprising: after displaying the second message in the user interface, receiving a new message from one of the plurality of users; identifying data in the new message associated with the second message; determining, based on the data associated with the second message, the new message is associated with the new topic; and after determining the new message is associated with the new topic, displaying the new message in the user interface within a group containing the second message.

Embodiments include a method comprising: receiving, at a communication system, electronic messages from a plurality of users participating in a group communication; identifying, by the communication system, data in a first message of the electronic messages associated with a topic; determining, based on the identified data, the first message is associated with the topic; appending, by the communication system, the first message with metadata identifying the topic; and transmitting, by the communication system, each of the electronic messages to a user device associated with one at least one of the users participating in the group communication, wherein the first message is appended with metadata identifying the topic.

Aspects of the above method include wherein identifying data in the first message of the electronic messages associated with the topic comprises comparing one or more text strings contained within the first message to text strings in a learning database containing training data, wherein the training data is used for machine learning.

Aspects of the above method include wherein each text string in the training data comprised by the learning database is associated with a particular topic.

Aspects of the above method include the method further comprising: after transmitting the electronic messages to the user device, receiving a new message from one of the plurality of users; identifying data in the new message associated with the topic; determining, based on the data associated with the topic, the new message is associated with the topic; after determining the new message is associated with the topic, appending the new message with metadata identifying the topic; and transmitting the new message to the user device, wherein the new message is appended with metadata identifying the topic.

Aspects of the above method include the method further comprising receiving text input from the user device associated with a second message of the electronic message; and in response to the text input, creating a new topic and appending the second message with metadata identifying the new topic.

Aspects of the above method include wherein the new topic and text of the second message are stored in a learning database.

Aspects of the above method include wherein a third message is automatically identified as being associated with the new topic based on the text of the second message.

Aspects of the above method include the method further comprising: after appending the second message with metadata identifying the new topic, receiving a new message from one of the plurality of users; identifying data in the new message associated with the second message; determining, based on the data associated with the second message, the new message is associated with the new topic; and after determining the new message is associated with the new topic, appending the new message with metadata identifying the new topic.

Embodiments include a system comprising: at least one processor; and computer-readable storage medium storing instructions that, when executed by the at least one processor, cause the system to: receive electronic messages from one or more user devices associated with a plurality of users participating in a group communication; identify data in a first message of the electronic messages associated with a topic; determine, based on the identified data, the first message is associated with the topic; receive a request from a first user; and in response to the request, rearrange the electronic messages in a user interface of the user device based on topic associations.

Aspects of the above system include wherein the instructions further cause the system to: receiving a second request from the first user; and in response to the second request, rearranging the electronic messages in the user interface based on the chronological order.

Aspects of the above system include wherein identifying data in the first message of the electronic messages associated with the topic comprises comparing one or more text strings contained within the first message to text strings in a learning database comprising training data, wherein the training data is used for machine learning.

Aspects of the above system include wherein each text string in the training data comprised by the learning database is associated with a particular topic.

Aspects of the above system include wherein the instructions further cause the system to: after rearranging the electronic messages in the user interface based on topic associations, receive a new message from one of the plurality of users; identify data in the new message associated with the topic; determine, based on the data associated with the topic, the new message is associated with the topic; and after determining the new message is associated with the topic, display the new message in the user interface within a group containing the first message.

Aspects of the above system include wherein the instructions further cause the system to: receive input from the first user associated with a second message of the electronic messages; in response to the input, display one or more topic labels and a text field; receiving text input in the text field; in response to the text input, create a new topic and displaying the second message in the user interface in a group associated with the new topic.

Aspects of the above system include wherein the new topic and text of the second message are stored in a learning database.

Aspects of the above system include wherein a third message is automatically identified as being associated with the new topic based on the text of the second message.

Aspects of the above system include wherein the instructions further cause the system to: after displaying the second message in the user interface, receive a new message from one of the plurality of users; identify data in the new message associated with the second message; determine, based on the data associated with the second message, the new message is associated with the new topic; and after determining the new message is associated with the new topic, display the new message in the user interface within a group containing the second message.

Aspects of the above system include wherein displaying the second message in the user interface comprises displaying one or more of a title of the new topic, an identification of a user participating in the communication group having started the new topic, a timestamp indicating a date and/or time the new topic was started, a graphical user interface button enabling a collapsible view, a graphical user interface button enabling filtering based on time, a graphical user interface button enabling a user to view all of messages posted by the within the new topic and/or across topics.

Examples of the processors as described herein may include, but are not limited to, at least one of Qualcomm® Snapdragon® 800, 810, 820, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Rockchip RK3399 processor, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A method comprising:
receiving two or more electronic messages from one or more user devices participating in a group communication, wherein the two or more electronic messages are displayed in a user interface in a first order based on chronology;
identifying data associated with a topic in a first message of the two or more electronic messages;
determining, based on the identified data, the first message is associated with the topic;
receiving a request from a first user device; and
in response to the request, displaying the two or more electronic messages in the user interface in a second order based on topic associations, wherein in the first order the first message is displayed above a second message, and wherein in the second order the second message is displayed above the first message.

2. The method of claim 1, wherein identifying data associated with the topic in the first message comprises comparing one or more text strings contained within the first message to text strings in a learning database comprising training data, wherein the training data is used for machine learning.

3. The method of claim 2, wherein each text string in the training data comprised by the learning database is associated with a particular topic.

4. The method of claim 1, further comprising:
after displaying the two or more electronic messages in the user interface in the second order, receiving a new message from one of the user devices;
identifying data associated with the topic in the new message;
determining, based on the data associated with the topic, the new message is associated with the topic; and
after determining the new message is associated with the topic, displaying the new message in the user interface within a group containing the first message.

5. The method of claim 1, further comprising:
receiving input associated with a second message of the two or more electronic messages from the first user device;
in response to the input, displaying one or more topic labels and a text field;
receiving text input in the text field; and
in response to the text input, creating a new topic and displaying the second message in the user interface in a group associated with the new topic, wherein the new topic is associated with a title comprising the text input.

6. The method of claim 5, wherein a third message is automatically identified as being associated with the new topic based on the text of the second message.

7. The method of claim 5, further comprising:
after displaying the second message in the user interface,
receiving a new message from one of the plurality of users;
identifying data associated with the second message in the new message;
determining, based on the data associated with the second message, the new message is associated with the new topic; and
after determining the new message is associated with the new topic, displaying the new message in the user interface within a group containing the second message.

8. The method of claim 1, wherein displaying the two or more electronic messages in the user interface in the second order comprises displaying an identification of a user participating in the communication group having sent an earliest message associated with the topic.

9. The method of claim 1, further comprising displaying a graphical user interface button enabling a user to view all messages posted by a particular user of the plurality of users participating in the group communication associated with the topic.

10. A method comprising:
receiving, at a communication system, a first electronic message from a first user device of a plurality of user devices participating in a group communication;
identifying, by the communication system, data associated with a topic in the first message;
determining, based on the identified data, the first message is associated with the topic;
in response to determining the first message is associated with the topic, generating, by the communication system, metadata indicating the first message is associated with the topic;
appending, by the communication system, the first message with the metadata indicating the first message is associated with the topic; and
transmitting, by the communication system, the first message appended with the metadata indicating the first message is associated with the topic to the plurality of user devices participating in the group communication.

11. The method of claim 10, wherein identifying data associated with the topic in the first message comprises comparing one or more text strings contained within the first message to text strings in a learning database containing training data, wherein the training data is used for machine learning.

12. The method of claim 11, wherein each text string in the training data comprised by the learning database is associated with a particular topic.

13. The method of claim 10, further comprising:
after transmitting the first message appended with the metadata indicating the first message is associated with the topic to the plurality of user devices, receiving a second electronic message from one of the plurality of user devices;
identifying data associated with the topic in the second message;
determining, based on the data associated with the topic, the second message is associated with the topic;
after determining the second message is associated with the topic, appending the second message with the metadata indicating the second message is associated with the topic; and
transmitting the second message appended with the metadata indicating the second message is associated with the topic to the plurality of user devices participating in the group communication.

14. The method of claim 10, further comprising:
receiving a text input associated with a second electronic message from a second user device participating in the group communication; and
in response to the text input, creating a new topic and appending the second message with metadata indicating the second message is associated with the new topic.

15. The method of claim 14, wherein the new topic and the second message are stored in a learning database.

16. The method of claim 15, wherein a third message is automatically identified as being associated with the new topic based on a text string comprised by the second message.

17. The method of claim 14, further comprising:
after appending the second message with the metadata indicating the second message is associated with the new topic, receiving a third message from one of the plurality of devices;
identifying data associated with the second message in the third message;
determining, based on the data associated with the second message, the third message is associated with the new topic; and
after determining the third message is associated with the new topic, appending the third message with metadata indicating the third message is associated with the new topic.

18. A system comprising:
at least one processor; and
a computer-readable storage medium storing instructions that, when executed by the at least one processor, cause the system to:
receive two or more electronic messages from one or more user devices participating in a group communication, wherein the two or more electronic messages are displayed in a user interface in a first order based on chronology;
identify data associated with a topic in a first message of the two or more electronic messages; determine, based on the identified data, the first message is associated with the topic;
receive a request from a first user device; and
in response to the request, display the two or more electronic messages in the user interface in a second order based on topic associations, wherein in the first order the first message is displayed above a second message, and wherein in the second order the second message is displayed above the first message.

19. The system of claim 18, wherein the instructions further cause the system to:
receive a second request from the first user device; and
in response to the second request, display the two or more electronic messages in the user interface in the first order.

20. (canceled)

21. The system of claim 18, wherein identifying data associated with the topic in the first message comprises comparing one or more text strings contained within the first message to text strings in a learning database comprising training data, wherein the training data is used for machine learning.
